(19) United States
(12) Patent Application Publication
(10) Pub. No.: US 2013/0016952 A1
(43) Pub. Date: Jan. 17, 2013

(54) FIBER OPTIC DISTRIBUTION DEVICE

(71) Applicant: Thomas Knuth, Berlin (DE)

(72) Inventor: Thomas Knuth, Berlin (DE)

(21) Appl. No.: 13/479,846

(22) Filed: May 24, 2012

(30) Foreign Application Priority Data
May 26, 2011 (EP) 11167711.8

(51) Int. Cl. G02B 6/46

(52) U.S. Cl. 385/135

(57) ABSTRACT

A fiber optic distribution device for indoor applications is disclosed. The fiber optic distribution device comprises a housing having at least one inlet opening for at least one first fiber optic cable having a plurality of optical fibers and a plurality of outlet openings for a plurality of second fiber optic cables each having at least one optical fiber branched off the or each first fiber optic cable. The housing comprises a flexible housing part being transferable between an open status having a flat shape and a closed status having a bent shape being partially wound around the first fiber optic cable.

### RELATED APPLICATIONS

This application claims the benefit of priority under 35 U.S.C. §119 of European Patent Application Serial No. 11167711.8 filed May 26, 2011 the content of which is relied upon and incorporated herein by reference in its entirety.

### BACKGROUND

1. Field of the Disclosure

The patent application relates to a fiber optic distribution device for indoor applications, especially to a floor box. Further on, the patent application relates to an assembly comprising such a fiber optic distribution device and fiber optic cables.

2. Technical Background

In the world of the ever-increasing need for broadband bandwidth optical cables have become the main part of telecommunication networks. Optical cables can transmit voice signals, data signals and video signals for very long distances with very high speed. Developments of optical telecommunication networks allow the connection of the end user directly to the optical fiber. This kind of network technology known as FTTH technology (fiber to the home) requires extending an “all optical” communication network closer to the subscribers. As a result such telecommunication networks include large number distribution points from a distribution cable to an end user or subscriber.

One of the key parts of the FTTH network is the last mile connection which often is an indoor installation. Different kind of buildings like multi dwelling units and block of flats require complicated cabling systems which might mean that there are many separated cables, each one to connect one subscriber. Installation of many cables which provide the connection between a main distribution point, which usually is located in the basement or in another place of the building, and the end user may cause many problems with routing through the wall or levels of the building. As a result, such installations consume a lot of time and costs.

Another way to provide the connection between the main distribution point and the end user or subscriber is by using an optical cable comprising a riser cable with branched off tether cables, whereby the riser cable is to be connected to the main distribution point via a distribution cable, and whereby the tether cables are to be connected to subscribers via a drop cables. The installation of an optical cable comprising a riser cable and branched off tether cables to provide connection between the main distribution point and the subscribers is done by a highly skilled field technician using standard fiber optic distribution devices which results in high costs of installation.

In each case it is necessary to handle connections and/or splices between optical fibers of a first fiber optic cable, e.g. of a riser cable or alternatively a tether cable, having a plurality of optical fibers and optical fibers of a plurality of second fiber optic cables, e.g. to tether cables or alternatively drop cables, each having at least one optical fiber branched off the or each first fiber optic cable.

Such connections and/or splices are handled in so called fiber optic distribution devices like floor boxes or wall boxes. Such fiber optic distribution device known from the prior art comprise housings being rigid and bulky. The use of those very often bulky housings in e.g. stairway areas of a building is sometimes problematic for example due to space requirements or considerations of fire protection, especially when those boxes are mounted visibly on the wall in staircases.

### SUMMARY

Against this background, a novel fiber optic distribution device for indoor applications is provided. The novel fiber optic distribution device is defined by claim 1. According to claim 1, the fiber optic distribution device comprises a housing, wherein said housing comprises a flexible housing part, said flexible housing part being transferable between an open status of the flexible housing part in which the same takes a flat shape and a closed status of the flexible housing part in which the same takes a bent shape being partially wound around the or each first fiber optic cable.

This invention allows cable termination points to reside inside existing duct architectures while still allowing the termination of cables in a standard way and maintaining flexibility of cable routing. The invention allows the termination of fibre optic cables in restricted spaces, avoiding floor termination boxes in public spaces. This helps to decrease fire load in each e.g. multi dwelling units. The advantage is that no stiff housing is used but a rather flexible housing, allowing the cable installation in given duct systems. This avoids problems during installation and therefore speeds up deployment of FTTH as well as lowers the fire load in publically used areas.

### BRIEF DESCRIPTION OF THE FIGURES

Preferred embodiments of the fiber optic distribution device and fiber optic network are given in the dependent claims and the description below. Exemplary embodiments will be explained in more detail with reference to the drawing, in which:

FIG. 1 shows a schematic view of a fiber optic distribution device in an open status of the same; and

FIGS. 2 and 3 each show schematic views of a fiber optic distribution device in a closed status of the same.

### DETAILED DESCRIPTION

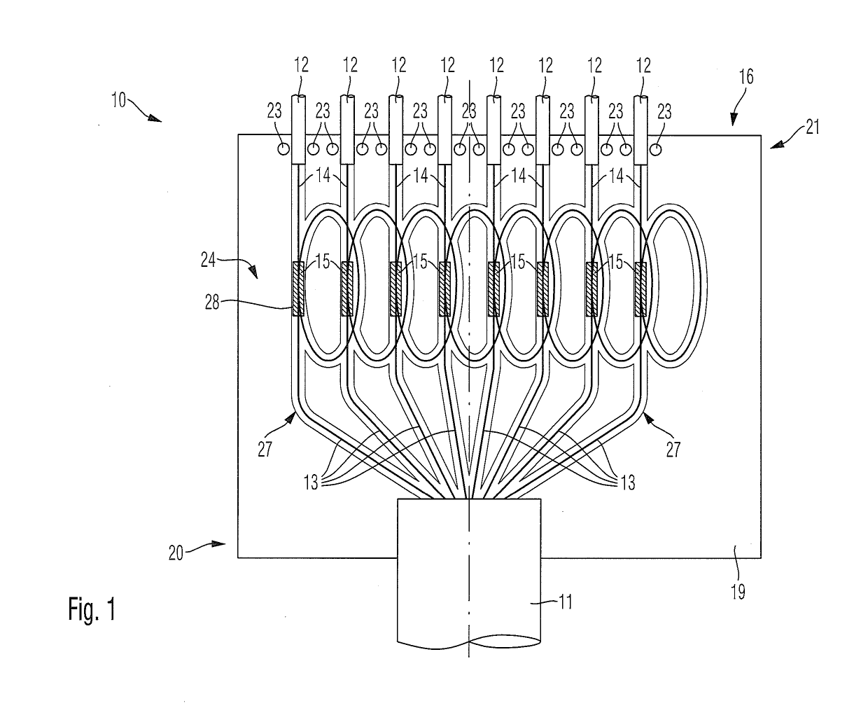

FIGS. 1, 2 and 3 show a preferred embodiment of a fiber optic distribution device 10 for indoor applications in combination with a single first fiber optic cable 11 and a plurality of second fiber optic cables 12.

The shown first fiber optic cable 11 can be a riser cable or alternatively a tether cable having a plurality of optical fibers 13. The shown second fiber optic cables 12 can be tether cables or alternatively drop cables each having at least one, in the shown embodiment a single one, optical fiber 14 branched off the or each first fiber optic cable 11.

The optical fibers 14 of the second fiber optic cables 12 are connected with the optical fibers 13 of the first fiber optic cable 11 by splices or connectors. The embodiment shows splices 15 between the same.

The connection points or splices 15 between the optical fibers 13, 14 are handled in said fiber optic distribution device 10.

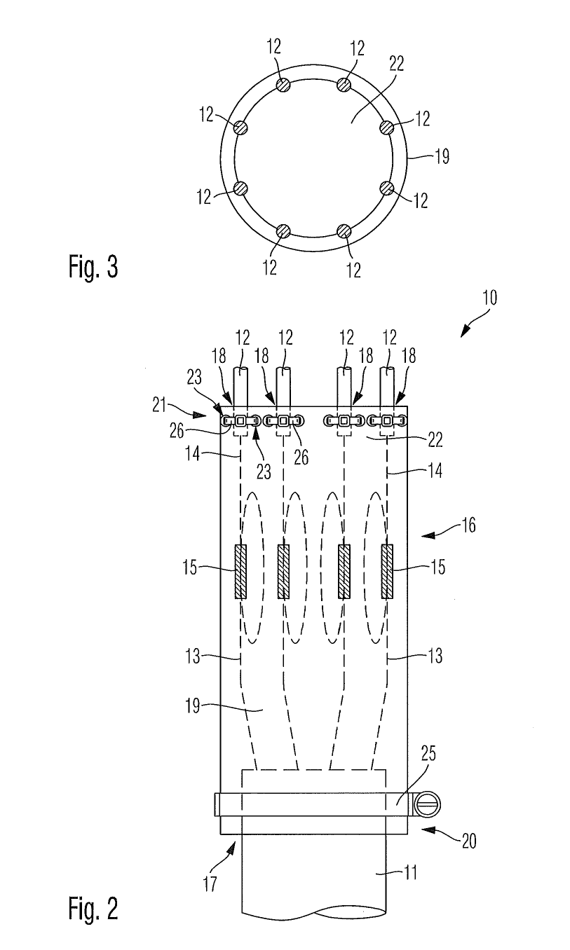

The fiber optic distribution device 10 comprises a housing 16. Said housing 16 provides an inlet opening 17 for said first fiber optic cable 11 and a plurality of outlet openings 18 for said plurality of second fiber optic cables 12. The housing 16 comprises a flexible housing part 19. Said flexible housing part 19 is transferable between an open status (see FIG. 1) in which the same takes a flat shape and a closed status (see FIGS. 2 and 3) in which the same takes a bent shape being partially wound around the first fiber optic cable 11.

In the closed status—FIG. 2 shows a side view and FIG. 3 a top view of the closed status—of the flexible housing part 19 a first end 20 of said flexible housing part 19 providing said inlet opening 17 is wound around said first fiber optic cable 11 and fixed at said first fiber optic cable 11 by a fixing element 25. Said fixing element 25 is preferably a cable tie or a cable clamp.

In the closed status (see FIGS. 2 and 3) of the flexible housing part 19 a second end 21 of said flexible housing part 19 is closed by plug element 22 (see FIG. 2) providing said plurality of outlet openings 18 for said plurality of second fiber optic cables 12.

Said second end 21 of said flexible housing part 19 provides strain relief elements for said second fiber optic cables 12. Said second end 21 of said flexible housing part 19 comprises openings 23 for cable ties 26 so that each of said second fiber optic cables 12 is individually strain reliefable by a cable tie 26 being thread through two respective openings 23 and surrounding the respective second fiber optic cable 12 and the respective segment of said second end 21 of said flexible housing part 19.

A wall 24 of said flexible housing part 19 which in the closed status of the same corresponds to an inner wall of the flexible housing part 19 provides fiber routing elements 27 for optical fibers 13, 14 and holding elements 28 for the splices 15 and/or for connectors by which the optical fibers 13, 14 are spliced and/or connected to each other.

Said housing 16, namely at least the flexible housing part 19, is made from a flexible plastic material like a flexible thermoplastic material. It is also possible that the plug element 22 is made from such a flexible plastic material like a flexible thermoplastic material.

The flexible housing part 19 holds splices 15 and fibre routing elements in the inside. For installation the flexible housing part 19 is put in a flat shape (see FIG. 1) to allow the installation of the splices 15 into the respective holding elements as well as the fibre routing inside the respective fiber routing elements.

The first fibre optic cable 11 is strain relieved on the lower end 20 of the flexible housing part 19 as well as the second fiber optic cables 12 are strain relieved on the upper end 21 of the flexible housing part 19.

Once the fiber optic cables 11, 12 are secured, the fibers 13, 14 of the same are spliced and stored at the flexible housing part 19, the flexible housing part 19 is rolled together and fixed in this position to be aligned with and conform to the shape of the first fiber optic cable 11. This creates a somewhat thicker cable shape and due to the flexible material of the housing part 19 the same can be bent in various directions to follow existing duct structures.

Due to the thin shape and flexible material of the housing part 19 the fiber optic distribution device 10 can be stored inside cable ducts without being in danger of compromising the minimum bend diameter of the optical fibers 13, 14.

What is claimed is:

1. A fiber optic distribution device, comprising:
a housing, having at least one inlet opening for at least one first fiber optic cable having a plurality of optical fibers and a plurality of outlet openings for a plurality of second fiber optic cables each having at least one optical fiber branched off the or each first fiber optic cable,
wherein the housing comprises a flexible housing part, the flexible housing part being transferable between an open status of the flexible housing part in which the flexible housing part takes a flat shape and a closed status of the flexible housing part in which the flexible housing part takes a bent shape being partially wound around the or each first fiber optic cable.

2. The fiber optic distribution device of claim 1, wherein the flexible housing part comprises a first end which in the closed status is wound around a first fiber optic cable and fixed at the first fiber optic cable by a fixing element.

3. The fiber optic distribution device of claim 2, wherein the fixing element is a cable tie or a cable clamp.

4. The fiber optic distribution device of claim 2, wherein the flexible housing part comprises a second end.

5. The fiber optic distribution device of claim 4, further comprising a plug element, wherein when in the closed status the second end is closed by plug element.

6. The fiber optic distribution device of claim 5, wherein the plurality of outlet openings are through the plug element.

7. The fiber optic distribution device of claim 4, wherein the second end of the flexible housing part provides strain relief elements for the second fiber optic cables.

8. The fiber optic distribution device of claim 7, wherein the second end of the flexible housing part comprises openings for cable ties.

9. The fiber optic distribution device of claim 8 wherein one or more of the second fiber optic cables is strain reliefable by cable ties surrounding the respective second fiber optic cable.

10. The fiber optic distribution device of claim 1, wherein the flexible housing part comprises a wall which corresponds to an inner wall of the flexible housing part when in the closed status.

11. The fiber optic distribution device of claim 10, further comprising fiber routing elements for optical fibers of at least one of the first fiber optic cable and of one or more of the second fiber optic cables.

12. The fiber optic distribution device of claim 10, further comprising holding elements for one or both of splices and connectors by which optical fibers of the or each first fiber optic cable and optical fibers of the second fiber optic cables are spliced and/or connected to each other.

13. The fiber optic distribution device of claim 1, wherein the housing is made from a flexible plastic material like a flexible thermoplastic material.

14. The fiber optic distribution device as claimed in claim 13, wherein the flexible housing part is made from the flexible plastic material.

15. The fiber optic distribution device of claim 13, further comprising a plug element, wherein the plug element is made from the flexible plastic material.
